(19) United States
(12) Patent Application Publication
(10) Pub. No.: US 2024/0313897 A1
(43) Pub. Date: Sep. 19, 2024

(54) METHODS AND CONTROLLERS FOR CONTROLLING MEMORY OPERATIONS

(71) Applicants: PICOCOM TECHNOLOGY LIMITED, Bristol (GB); PICOCOM (HANGZHOU) CO., LTD., Hangzhou (CN)

(72) Inventors: Martin Lysejko, Bristol (GB); William Philip Robbins, Bristol (GB); Yu Huai, Hangzhou (CN)

(21) Appl. No.: 18/260,787

(22) PCT Filed: Jan. 7, 2022
(86) PCT No.: PCT/GB2022/050027

§ 371 Date: Jul. 9, 2023

(51) Int. Cl. H04L 1/1812; H04L 1/1829

(52) U.S. Cl. CPC H04L 1/1819; H04L 1/1835

(57) ABSTRACT

Methods and controllers for controlling memory operations wherein a plurality of data sets are stored in memory or read from memory by storing or reading the most significant bits of each data set first, and subsequently storing or reading the next most significant bits of the each data set.

### FIELD

The present disclosure relates to methods and controllers, devices and circuitry for controlling memory operations and in particular to controlling reading and writing operations.

The present application claims the Paris Convention priority from United Kingdom Patent application number 2100653.1, the contents of which are hereby incorporated by reference.

### BACKGROUND

New radio access technologies, such as 3GPP 5G New Radio “NR”, brings dramatic increases in throughputs such as multi-gigabit over-the-air rates. Designing hardware that is able to handle such rates can be challenging, for example for baseband System-on-Chip (SoC) designers.

In particular, recent technological developments are associated with an increased amount of storage required (e.g. for Hybrid-ARQ (HARQ) or retransmissions mechanisms to function) and increased associated transfer rates to memory, for example off-chip Double Data Rate (DDR) memory.

While these challenges are presently particularly relevant to 5G, these challenges are expected to be even more relevant to future technologies.

Accordingly, it is desirable to provide arrangements which can improve the operation of memory, in particular the management of writing and reading operations in memory.

### SUMMARY

According to a first aspect of the present disclosure, there is provided a method of controlling memory operations, the method comprising identifying a plurality of data sets to store in memory, each data set comprising two or more bits ordered from a most significant bit to a least significant bit; storing in memory a first plurality of bits selected from the bits for the plurality of data sets, wherein the first plurality of bits is selected by selecting one or more successive first bits of each data set, including the most significant bit of the each data set, wherein the stored one or more successive first bits of the each data set define a stored portion of the each data set; and storing in memory a further plurality of bits selected from the bits for the plurality of data sets, wherein the further plurality of bits is selected by selecting one or more successive further bits of each data set, outside the stored portion and including the most significant bit outside the stored portion of the each data set. Accordingly, writing operations can be controlled in a manner which is expected, amongst other things, to assist with controlling and/or minimising the impact of congestion effecting memory operations.

According to a second aspect of the present disclosure, there is provided a method of controlling memory operations, the method comprising: identifying a plurality of data sets to read from memory, each data set comprising two or more bits ordered from a most significant bit to a least significant bit; reading from memory a first plurality of bits selected from the bits for the plurality of data sets, wherein the first plurality of bits is selected by selecting one or more successive first bits of each data set, including the most significant bit of the each data set, wherein the read one or more successive first bits of the each data set define a read portion of the each data set; and reading from memory a further plurality of bits selected from the bits for the plurality of data sets, wherein the further plurality of bits is selected by selecting one or more successive further bits of each data set, outside the read portion and including the most significant bit outside the read portion of the each data set. Accordingly, writing operations can be controlled in a manner which is expected, amongst other things, to assist with controlling and/or minimising the impact of congestion effecting memory operations.

According to a third aspect of the present disclosure, there is provided a controller for controlling memory operations, controller being configured to identify a plurality of data sets to store in memory, each data set comprising two or more bits ordered from a most significant bit to a least significant bit; store in memory a first plurality of bits selected from the bits for the plurality of data sets, wherein the first plurality of bits is selected by selecting one or more successive first bits of each data set, including the most significant bit of the each data set, wherein the stored one or more successive first bits of the each data set define a stored portion of the each data set; and store in memory a further plurality of bits selected from the bits for the plurality of data sets, wherein the further plurality of bits is selected by selecting one or more successive further bits of each data set, outside the stored portion and including the most significant bit outside the stored portion of the each data set.

According to a fourth aspect of the present disclosure, there is provided a controller for controlling memory operations, controller being configured to identify a plurality of data sets to read from memory, each data set comprising two or more bits ordered from a most significant bit to a least significant bit; read from memory a first plurality of bits selected from the bits for the plurality of data sets, wherein the first plurality of bits is selected by selecting one or more successive first bits of each data set, including the most significant bit of the each data set, wherein the read one or more successive first bits of the each data set define a read portion of the each data set; and read from memory a further plurality of bits selected from the bits for the plurality of data sets, wherein the further plurality of bits is selected by selecting one or more successive further bits of each data set, outside the read portion and including the most significant bit outside the read portion of the each data set.

According to a fifth aspect of the present disclosure, there is provided a controller system comprising a writing controller in accordance with the third aspect above and a reading controller in accordance with the fourth aspect above.

Accordingly there has been provided methods and controllers for controlling memory operations wherein a plurality of data sets are stored in memory or read from memory by storing or reading the most significant bits of each data set first, and subsequently storing or reading the next most significant bits of the each data set.

### LIST OF FIGURES

A more complete appreciation of the disclosure will become better understood by reference to the following example description when considered in connection with the accompanying drawings wherein like reference numerals designate identical or corresponding parts throughout the several views.

FIG. 1 illustrates an example of a retransmission mechanism.

FIGS. 2A and 2B illustrates examples HARQ buffers after various transmissions.

FIG. 3 illustrates an example decoding chain at a wireless receiver.

FIGS. 4A to 4D illustrate example communications with the HARQ buffer during retransmissions.

FIG. 5 illustrates an example structure for a wireless receiver.

FIG. 6A illustrates an example arrangement for handling LLR sample storing in a HARQ buffer.

FIG. 6B illustrates an example compression method for reducing the size of LLRs FIG. 7 illustrates an example HARQ buffer.

FIGS. 8A to 8C illustrate an example use of the buffer of FIG. 7 during transmissions and re-transmissions.

FIG. 9 illustrates an example controller in accordance with the present disclosure.

FIGS. 10A to 10C illustrate an example use of a HARQ buffer in accordance with the present disclosure.

FIG. 11 illustrates another example of a HARQ buffer.

FIG. 12 illustrates another view of the HARQ buffer of FIG. 11.

FIGS. 13A to 13C illustrate an example use of the buffer of FIG. 11 during transmissions and re-transmissions.

FIG. 14 illustrates an example use the buffer of FIG. 11.

FIG. 15 illustrates an example method of the present disclosure, for storing in memory.

FIG. 16 illustrates an example method of the present disclosure, for reading from memory.

FIG. 17 illustrates an example latency detection arrangement in accordance with the present disclosure.

FIG. 18 illustrates an example memory re-ordering technique in an LLR-write operation.

FIG. 19 illustrates an example memory re-ordering technique in an LLR-read operation.

FIG. 20 illustrates an example of bit ordering in a memory.

FIG. 21 illustrates an example soft combining operation using partial LLR samples.

FIG. 22 illustrates an example “padding” of a partial LLR sample.

### EXAMPLE DESCRIPTION

The present disclosure includes example arrangements falling within the scope of the claims and may also include example arrangements which may not necessarily fall within the scope of the claims but which are then useful to understand the teachings and techniques provided herein.

Most radio access technology communication systems are expected to include two features for the wireless nodes (e.g. mobile terminal, base station, remote radio head, relay, etc.) to manage errors in transmissions: (1) an error correction mechanism and (2) a retransmission mechanism.

As the skilled will appreciate, error correction mechanisms generally involve transmitting, alongside the bits to be communicated (which will be referred herein as “information bits”), parity bits. The parity bits can include Cyclic Redundancy Check “CRC” bit that can be used to determine if the received transmission contained any error. The parity bits can also include Forward Error Cording “FEC” bits we can be used to recover the originally transmitted bit (e.g. the originally transmitted information bits) even when the received bits contained errors.

In cases where there were an errors in the received bits (and, if FEC is available, where the errors could not be corrected), the receiver can report that the transmission was unsuccessful and retransmission mechanisms can then be used to have a successful transmission instead. In some cases, the retransmission will involve re-sending the same transmission and in other cases, the retransmission may include sending a different transmission which may be entirely different from the first transmission or which may at least partially overlap with the first transmission.

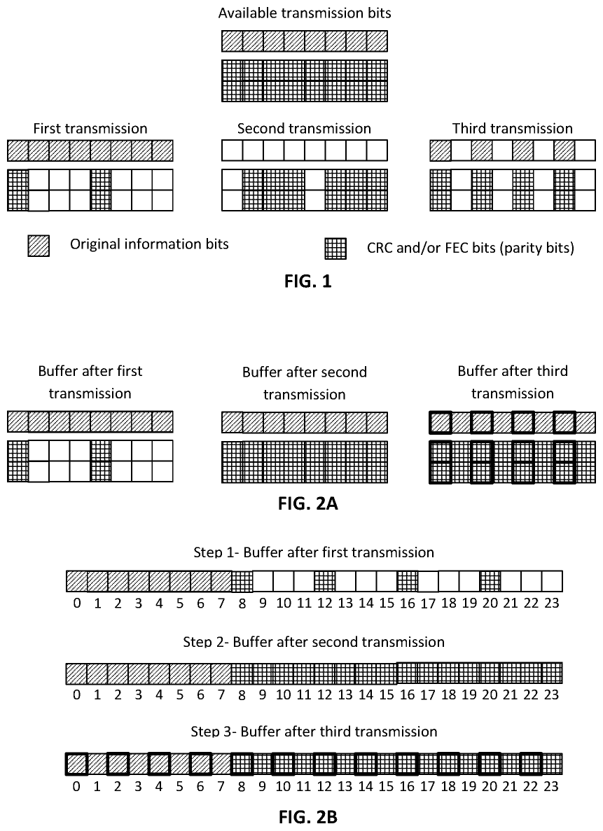

FIG. 1 illustrates an example of a retransmission mechanism which corresponds to the latter case. In the top portion, all of the bits that may be transmitted (hereinafter referred to as “coded bits”) are defined. The coded bits will generally include a portion comprising information bit and, optionally, a portion comprising one or more parity bits such as CRC and/or FEC bits.

In this example, all of the coded bits that may be transmitted by the sender include 8 bits of information bits (e.g. the actual data to be transmitted) and 16 bits of parity bits. It will be appreciated that these values are illustrative only and that the amount of information and/or parity bit may vary greatly, as deemed appropriate based on the transmission parameter, communication standards or any other relevant factor. For example, in 5G NR it is expected that a coded block may include 25344 coded bits. The skilled person will appreciate that the teachings provided in the present disclosure apply equally to such and other cases.

In present mobile telecommunication networks and for example in 5G NR networks, a configuration where retransmissions attempts may send a different selection of coded bits compared to a previous transmission is sometimes called “incremental redundancy”. Using this terminology, the first transmission is sometimes identified as “RV0” (Redundancy Version 0), the first retransmission as “RV1”, the second retransmission as “RV2” and so on. In 5G NR, a HARQ cycle with incremental redundancy can extend to up to four transmissions (e.g. RV0 to RV3) before the redundancy check (CRC test) either passes or fails. While this terminology is widely used in the present disclosure, the skilled person will appreciate that present principles are not limited to applications in 5G NR or generally to 3GPP communications but is instead applicable to other situations.

Returning the example of FIG. 1, the coded bits comprise 24 bits and 12 bits can be transmitted each time. In the first transmission RV0, all of the information are transmitted (8 bits) as well as some of the parity bits (4 bits). In the second transmission (first retransmission) RV1, only parity bits are transmitted (12 bits). In the third transmissions (second retransmission) RV2, a mixture of information bits (4 bits) and parity bits (8 bits) are sent. The skilled person will be able to appreciate how to select information bits and parity bits to be transmitted at each transmission or retransmission and this is beyond the scope of the present disclosure.

The examples of the present disclosure have been generally provided so as to correspond to the example of FIG. 1 for ease of understanding the different benefits and trade-offs associated with each example arrangement provided herein. However, the skilled person will appreciate that the present disclosure is not limited to the example of FIG. 1 and can be use equally in other examples.

FIGS. 2A and 2B illustrates example view of a HARQ buffer after various transmissions, corresponding to the example of FIG. 1. It is noteworthy that FIGS. 2A and 2B can be viewed from a physical perspective or from a logical perspective, as will be clear below.

After the first transmissions, the buffer for the coded bits will include what was received from the transmitted bits. In this example, this transmission will correspond to the eight (8) information bits and the four (4) parity bits transmitted. After this transmission, the buffer or memory for receiving the transmission will have some but not all of the received coded bits.

Assuming an unsuccessful first transmission, the second transmission will send the 12 parity bits not yet sent. The receiver will therefore have received all coded bits either through the first or second transmission. Accordingly, the buffer or memory for the transmission will have information for each of the coded bits.

Assuming that the device was still not able to decode the coded bits even after the second transmission, a third transmission will be sent as illustrated in FIG. 1. Following the second transmission, the receiver will have received some of the coded bits twice—in this case, the coded bits transmitted with the third transmission (second re-transmission). This is illustrated with the thicker lines outside the coded bits received twice in FIG. 2A.

The same example is illustrated in FIG. 2B which shows the same buffers but illustrated in a linear fashion, with memory resources allocated to the coded bit, from coded bit 0 to coded bit 23.

As the skilled person will know, when the same coded bit is received more than once, the receiver can use the various received versions of the coded bits in different ways. In one example, the receiver can use the last one, the one deemed the “better” or “stronger” one or can use soft addition of what was received. Effectively, the coded bit is either 0 or 1 but it is transmitted through a physical (analogue) signal such that the receiver may associated the received transmission with a score indicating whether the code is closer to 0 or 1. By combining the score for more than one transmission, any interference or other factor that may have deteriorate the transmission of a coded bit is generally not expected to have affected two transmission of the same coded bit in a similar manner. Accordingly, by combining the score for the coded bit from two or more transmission, the reliability of the score is expected to increase compared to the score for any single transmission of the same coded bit. In other words, the probability to decode is expected to increase as a result of the soft combination of two or more transmissions.

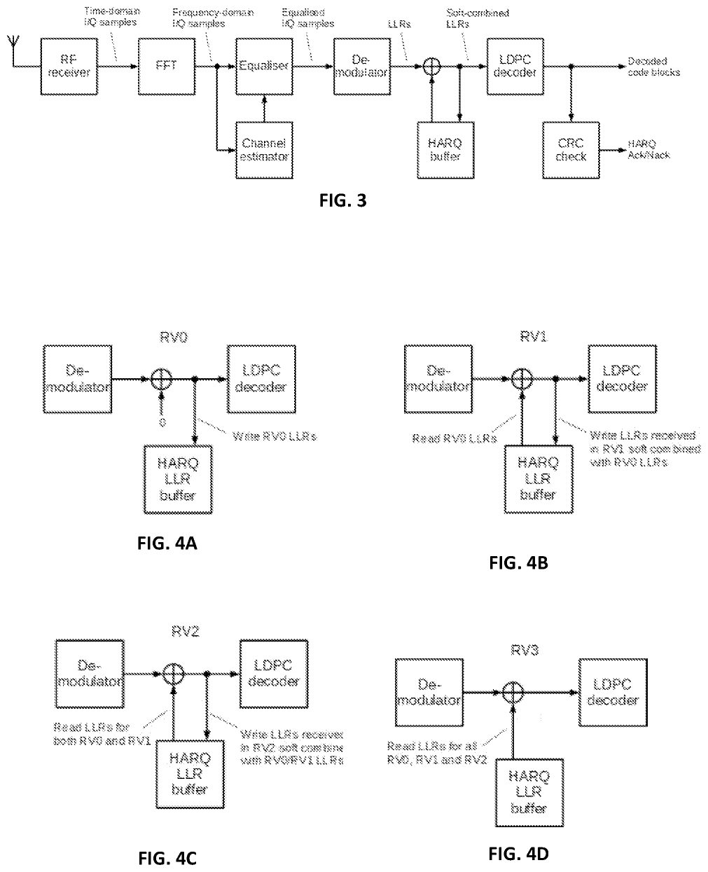

FIG. 3 illustrates an example decoding chain at a wireless receiver, for example similar to one that might be found in a 5G communication node. The signal from the receiver “RF receiver” is transmitted to a Fast Fourier Transform “FFT” function. The signal can then be adjusted based on channel estimations, using an equaliser before it is de-modulated. Before reaching the decoder “LDPC decoder” which attempts to decode the received signals, information about the received transmission is written in memory in case it is later needed after a further transmission. Information may also be read from memory, for example if any information from one or more previous transmissions was previously stored in memory. The decoder can then attempt to decode the coded bits using the information from the current transmission from any previous related transmission that may have been stored in memory. If the CRC check fails, this indicated that the decoding was unsuccessful. This can for example result in a further transmission of the same or related coded bits. If the decoding is successful, the information is passed on to further elements and possibly layer for processing.

The present disclosure focusses on memory operations, which in the example of FIG. 3 are particularly relevant to the read and write operations for the HARQ buffer. This part of FIG. 3 will therefore now be described in greater detail.

The demodulator outputs log likelihood ratios (LLRs) which can be used by the LDPC decoder. From one perspective, an LLR can be seen as a score associated with a coded bit and which represents the likelihood of the coded bit being 0 or 1. The LLRs in mobile network tend to be 8 bit long although other length can equally be used. The score is conventionally represented on a scale from −1 to 1 where a score of −1 indicates a coded bit value 0 and a score of 1 indicates a coded bit value 1.

FIGS. 4A to 4D illustrate example communications with the HARQ buffer during retransmissions. FIG. 4 illustrates example LLR transfers to and from the HARQ LLR buffer in a case where the transmissions go from a first transmission (RV0) to a fourth transmission (RV3). Each transfer is expected to correspond to a memory read or write operation.

As illustrated in FIG. 4A, in RV0 the transfers correspond to writing newly received LLRs into the HARQ buffers.

As illustrated in FIG. 4B, in RV1 these stored LLRs are retrieved and combined with newly received LLRs. The newly combined LLRs and/or RV1 LLRs are also written back in memory. Accordingly, the transfers are expected to correspond to twice the amount of LLRs or more: one set of LLRs is read and at least one set of LLRs (LLRs for RV1 and/or combined LLRs) are written.

As illustrated in FIG. 4C, in RV2 a similar process occurs. The amount of LLRs read may vary depending on whether the arrangement is configured to write at each retransmission one or both of the LLRs for the retransmission and the combined LLRs for all transmissions.

If the each set of LLRs are written at each transmission (and thus at each retransmission), then the LLRs for both RV0 and RV1 are read. Additionally, the LLRs for RV2 are written in memory. Accordingly, the transfers are expected to correspond to three times the amount of LLRs or more: two sets of LLRs are read and at least one set of LLRs (LLRs for RV1 and/or combined LLRs) are written. In a case where only combined LLRs are read, then the transfers are expected to correspond to twice the amount of LLRs or more.

As illustrated in FIG. 4D, in RV3 the previous LLRs are read, but no new LLRs are written back, as the HARQ cycle will terminate regardless of whether the decoding has been successful or not. Where combined LLRs are read, one set of LLRs is read from memory but in case where LLRs for each previous transmission is read, then three sets of LLRs are read, namely LLRs for RV0, RV1 and RV2—which can then be combined with the LLRs for RV3.

It is noteworthy that in cases where the LLRs for all transmissions are combined, it may be beneficial to only store combined LLRs, thereby reducing the amount of data to transfer at each retransmission. However, it is also conceivable that in some cases not all LLRs will be combined together such that each set of LLRs will be stored separately. While the memory resources and transfer required would be increased, such an arrangement may also result in an improved decoding rate. For example, the decoder can rate or score the quality or reliability of LLRs (e.g. by looking at whether one of the (re)transmissions was corrupted by an unscheduled transmission from another terminal, at whether one of the (re)transmissions was interrupted by a low latency transmissions and/or at a level of interference associated with the (re)transmissions, etc.) to assess how useful the LLRs are expected to be and/or can attempt to decode the coded bits by using different combinations of transmissions (e.g. RV0+RV2+RV3, RV0+RV1, etc.) thereby increasing the decoding attempts. In other words, an HARQ arrangement may involve storing the combined LLRs and/or each set of LLRs for one or previous transmission and the skilled person can determine which option is best suited to a particular system or environment, depending for example on processing power, memory capability and/or device cost.

Under normal conditions, over the air throughput is expected to be maximised when the number of HARQ retransmissions is kept below 20% of all transmissions, namely where 80% of transmissions do not go beyond RV0. Under adverse conditions, such as burst interference, HARQ re-transmissions may extend to RV3. In this scenario transfers to and/or from the HARQ buffer may increase three-fold compared to the data amounts transferred for RV0.

Additionally, with an increase data rate on the air interface, as for example provided with newer radio technologies like 5G NR, this will in turn create an increase amount of data to be transferred to or from memory.

It should also be noted that, without any additional memory optimisation, HARQ LLR bit rate for an N-bit LLR is expected to be of N times that of the over-the-air throughput. For example, for a 5G NR system capable of a 5 Gb/s throughput (measured in terms of number of coded bits transmitted over the air) and for a 8-bit LLR (with no compression or optimisation of the LLRs), such a system may generate 40 Gb/s of HARQ LLR samples, thus yielding a peak 120 Gb/s of HARQ LLR buffer throughput in the examples discussed above. Accommodating such a high data rate can require significant and costly memory to be used. Additionally or alternatively, this can result in an over-provisioning of memory resources in order to accommodate HARQ LLR buffer bandwidth requirements, where these peak requirements are only seldom used or needed.

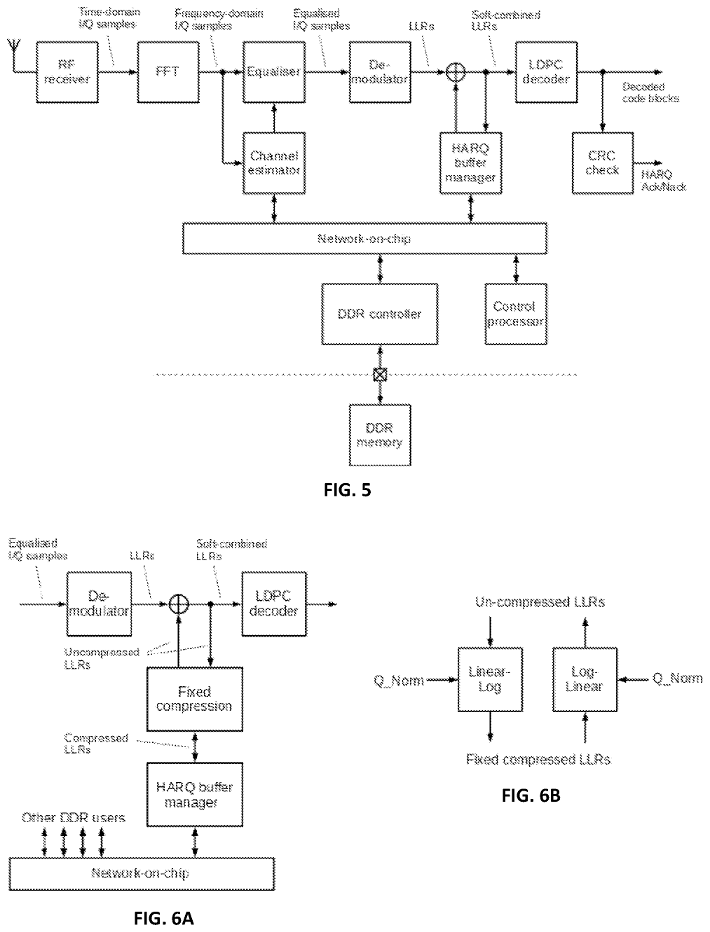

FIG. 5 illustrates an example structure for a wireless receiver where HARQ processing is shown in a System-on-Chip (SoC) context. In this example, the HARQ LLR samples are stored in an off-chip DDR memory. A HARQ buffer manager coordinates the transfer of LLR samples to or from the DDR memory via a Network-on-Chip (NoC) and DDR controller. It will usually be expected that the DDR memory is a pooled or shared resource utilised by many other functions of the device comprising the HARQ function (e.g. comprising the receiver). For example, data from other parts of the data-path illustrated in FIG. 3 or FIG. 5 may be stored there and read from there. Additionally or alternatively, code executed by various on-chip processors may also write and read data in the DDR.

Access to DDR may be arbitrated by NoC and DDR controller functions. However, in a case where multiple functions request access simultaneously, the peak load may significantly exceed that supported by the DDR sub-system. In such a case, the requesting functions can be delayed, waiting for DDR transactions to complete, slowing down processing possibly to the point where the data-path is not able to complete critical processing operations in time. Accordingly, ensuring that the HARQ system can use memory functions in time is an important factor in designing a HARQ system. Additionally, HARQ LLR storage represents a significant part of the overall DDR memory bandwidth budget in a system such as the one illustrated in FIG. 5. The present disclosure provides techniques and teachings which illustrates how memory demands may be tailored to operate within the confines of available DDR memory bandwidth and can be applied to cases where the memory demands are HARQ LLR demands.

One way to reduce the memory requirements when handling LLRs is to reduce the amount of data to be stored. With this in mind, some systems use a linear-log compression system in order to reduce the size of the stored LLR samples. FIG. 6A illustrates an example arrangement for handling LLR sample storing in a HARQ buffer and shows a method of compressing HARQ LLR samples using a fixed compression function, using a log-linear method, and a HARQ buffer manager that can then handle the compressed LLR samples writing and reading operations. In this example, prior to sending the LLR samples to the memory for storing they are reduced from a size of 8 bits to 6 bits. Accordingly, a 25% reduction in size and thus memory requirements can be achieved.

FIG. 6B illustrates an example compression method for reducing the size of LLRs where the amount of compression can be configured with the Q_Norm parameter or input for the Linear-Log compression and decompression functions. Such compression and decompression functions can for example be used in the arrangement of FIG. 6A. While such a type of compression is a lossy compression method (as opposed to a lossless compression method), the effect of the losses is expected to be acceptable due to the nature of the LLR sample and to their expected distributions and amplitudes. Said differently, with the fixed compression function of FIG. 6B using a simple logarithmic quantizer, simulations indicate quantization down to 6-bit is possible without significantly affecting the LDPC decoder performance.

While such an arrangement can help reduce the amount of data to be stored and read to 75% of the original data amounts, with the seen or expected increase in the available data rates over the air, further improvements would be desirable, which could help reduce the reliance on adding more memory to such systems.

As the skilled person will appreciate, increasing the level of compression of a log-liner function is likely to result in a detrimental level of losses in the decompressed LLR samples. Namely, this is likely to have a greater impact on the ability to decode the coded bit using the LLRs which is likely to reach undesirable levels. In addition, one option consists in adding more memory (e.g. more DDR) such that the read and write operations can be distributed across two or more memories, thereby reducing the likelihood of experiencing delay when there is a peak in memory operations. However, this option is associated with an increased device cost which can be undesirable in low-cost devices.

Accordingly, it would be helpful to provide additional or alternative techniques for managing memory operations.

FIG. 7 illustrates an example HARQ buffer. When storing LLR samples (also referred to as LLRs herein), the HARQ buffer is expected to be organised in a manner similar to that illustrated in FIG. 7. Namely, the HARQ buffer will have for any ongoing decoding attempt memory resources organised by coded bit wherein, for each coded bit, the memory resources comprise a number of bits corresponding to the LLR samples to be stored. In this example, there are 24 coded bits for consistency with the other examples herein as the skilled person that the techniques provided herein can be applied equally to more or fewer coded bits. Also, this example assumes that the LLR samples to be stored in and read from memory are 6 bit samples (e.g. because the LLR is coded by 6 bits, because it is coded by 8 bits and has been compressed to 6 bits, etc.). The skilled person will also appreciate that the same techniques can be applied to LLR samples (or more generally data to be stored in or read from memory) that can have more or fewer bits.

In the present disclosure, the terminology LLR(x,y) will refer to the LLR sample for a coded bit x, wherein the LLR(x,y) bit is in position y for this LLR sample. For example, in FIG. 7, the bits LLR(3,0) . . . LLR(3,5) correspond to the LLR sample for coded bit 3.

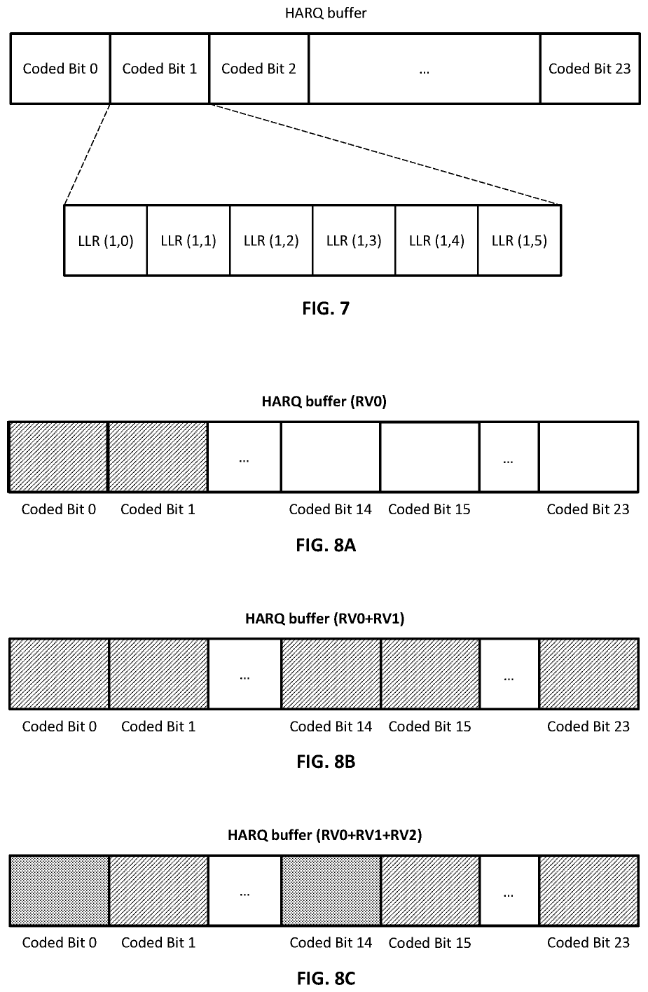

FIGS. 8A to 8C illustrate an example use of the buffer of FIG. 7 during transmissions and re-transmissions, namely in an example with three transmissions RV0 . . . RV2, i.e. with two retransmissions. In the interest of legibility only coded bits 0-1, 14-15, 23 have been represented but the example follows the same pattern of selection of coded for transmissions as illustrated in FIGS. 1 and 2. Accordingly, the examples of FIGS. 8A (after RV0 was received), 8B (after RV1 was received) and 8C (after RV2 was received) correspond to Step 1, Step 2 and Step 3 of FIG. 2B, respectively.

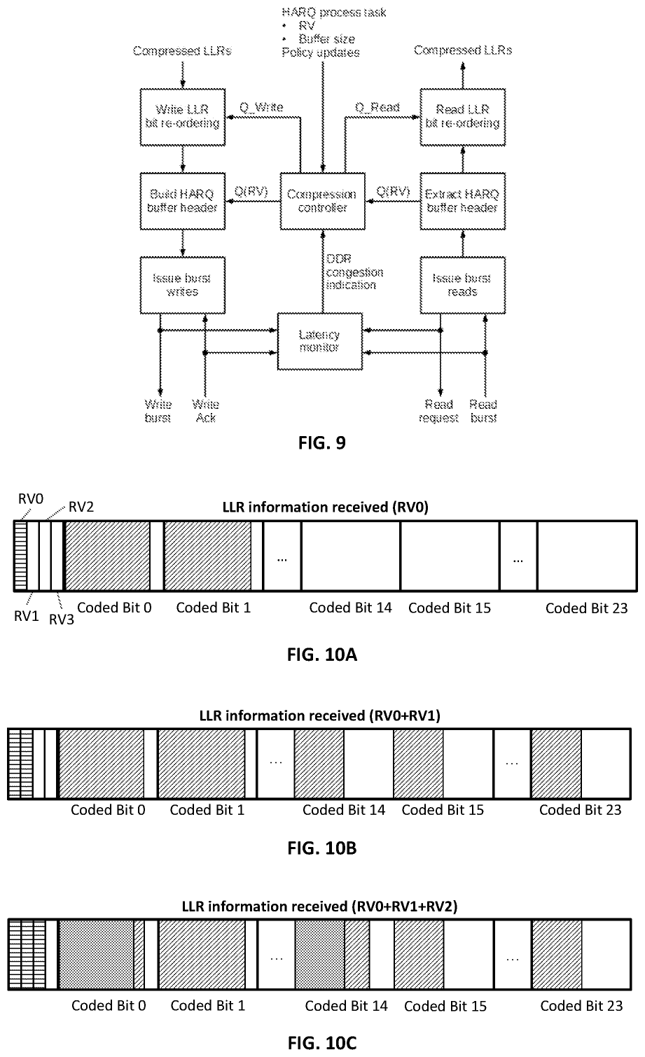

FIG. 9 illustrates an example controller in accordance with the present disclosure, such as HARQ Buffer Manager/Adaptive Compression sub-system. Such a controller can for example be used in combination with the HARQ buffer manager. The controller of FIG. 9 comprises, for writing management:

A “write LLR bit re-ordering” function configured to select LLR sample bits for writing and in particular, to select an order in which to write the LLR sample bits. This function is configured using a parameter Q_Write which can be derived from a performance score or load control parameter for the memory.
A “HARQ buffer header builder” function which is configured to take into account parameter Q(RV) based on the writing step.
A writing function (“Issue burst writes” in FIG. 9) which sends writing instructions, usually sent in burst (although not always). The writing function can also receive a confirmation when the data has been written and in some cases, when the data could not be written in memory.

The controller comprises the mirroring functions for reading management and further comprises the common function of:
A latency monitor which can monitor a latency in the memory operations (an in other cases, one or more other types of memory performances, additionally or alternatively) and which can output an indication of a level of congestion.
A compression controller which can configure a level of compression based on one or more of: a level of congestion or latency at the memory, a buffer size, a transmission or retransmission number and a policy or policy update.

According to this example, when latency and/or congestion is detected at the memory (e.g. through a delay between the read or write instructions and the read or write acknowledgement), the number of bits to be written in (or read from) memory can be reduced. Additionally, rather than merely reduce the number of bits to write in (or read from) memory, according to the techniques provided herein, the selection of the bits to write in (or read from) memory first is determined based on the most significant bits of each data set or word or LLR sample to be stored in memory.

In the example of FIG. 9, as DDR memory access becomes congested, read/write operations can be shortened to parts of the LLR buffer containing the more significant bits of the LLR samples. Said differently, adaptive compression can operate by streaming LLR samples into and out of DDR memory with most-significant bits grouped together, then lesser significant bit grouped together and so on.

Accordingly, even if the writing (or reading) of a plurality of data sets or words or LLR samples is interrupted before it is completed, the most significant bits of each data set, word or LLR sample would have been written (or read) before the least significant bits for the data set, word or LLR sample. When using such techniques with data sets like LLR or other data sets that may have similar characteristics, the amount of data to be stored or accessed can be reduced while still storing or accessing the most important part of the data.

It is worth noting that while such an arrangement may not bring an additional benefit on a case where data is more “random”, because an LLR is a score on a −1 to 1 scale, having the most significant bit already gives an indication of whether the score is positive or negative, even if no other bit is used. The next significant bit will give an indication of whether the score is in the above or below 0.5 (or −0.5 if the score is negative) and so on. Accordingly, even if the quality of the score will be less when only some of the bits are used, due to the nature of LLRs, using the most significant bits first still provide useful information. Accordingly, it is expected that having truncated or not complete but still useful information to use while be beneficial as it is likely to help avoiding an overall decoding failure (that might otherwise happen due to an unmanaged congestion).

FIGS. 10A to 10C illustrate an example use of a HARQ buffer in accordance with the present disclosure, in an example where headers are used. This example can for example use the controller of FIG. 9 and following the same transmission pattern as illustrated in FIGS. 1 and 2. In this example, it is assumed that congestion is detected at the memory such that at RV0, the writing is interrupted after writing 7 bits of each 8 bit LLR; at RV1, the writing is interrupted after writing 4 bits of the LRRs and at RV2, the writing is interrupted after writing 6 bits of LLRs. As the skilled person will appreciate, these values are only illustrative and, for each transmission, any value between 0 and 8 may be used for deciding how man bits to save for each LLR. Additionally, this example is based on uncompressed LLR being stored but the same teachings and techniques apply equally to compressed LLR samples, for example compressed down to 6 bits.

FIG. 10A illustrates the HARQ buffer after the seven most significant bits of each LLR sample are being saved. When compared to FIG. 8A, it can be seen that there is LLR data for the same coded bit but not all the LLR bits are stored. In particular, for coded bit 0, LLR bits LLR(0,0) to LLR(0,6) are stored but LLR(0,7) is not stored, to save bandwidth in the transmissions to the memory. In this example, the HARQ buffer also includes a header which can indicate for RV0, how many LLR bits have been stored. For example, the header section for RV0 could indicate a value of 7 (for seven stored bits), of 1 (for one non-stored bit) or another value indicative of the number of bits that have been stored (or not stored). As will be appreciated, the header section in FIGS. 10A to 10C may not be to scale as the header section RV0 (or any of RV1 to RV3) may include more than one bit.

In examples where headers are used, shortened LLR samples can be marked in the header, for example in a Q(RV) value indicating how many bits were stored. Depending on how the memory operates and has been designed, this can help reduce the likelihood of subsequent reading operations attempting to access an invalid sample (e.g. a full LLR sample when only a partial LLR sample was stored). Accordingly, in some circumstances memory reading errors can be avoided or reduced in number.

Likewise, FIG. 10B illustrates the buffer after the next set of LLRs has been stored. In this example, the writing was interrupted at 4 bits such that, for each coded bit n that is received, LLR bits LLR(n,0) to LLR(n,3) are stored and LLR(n,4) to LLR(n,7) are not stored. As can be seen in FIG. 10B, the memory will then only have stored the three most significant bits for coded bits 14, 15 and 23 (and other coded bits received at RV1). The header will also include an indication that for RV1, four bits of each LLR samples were stored.

FIG. 10C illustrates what has been received and stored after RV2. For the LLR samples corresponding to the second retransmission RV2, 6 bits of each LLR sample is being stored. As illustrated in FIG. 10C, for at least coded bits 0 and 14, some of the LLR information would have been received twice. It will be appreciated that the representation of FIG. 10C is illustrative only and the LLR bits may not be overwritten by the more recent ones (and as they correspond to LLR bits, they will take a discreet 0 or 1 value). For example and as discussed above, the LLR samples for the different transmissions can be stored separately, or may be combined so that the combined version is stored, either with or without the corresponding LLR samples. For example, for coded bit 14, one LLR sample was stored with 3 bits stored from the original LLR sample and another sample only had 4 bits of the original LLR sample stored. Therefore, in total, the HARQ sub-system will only be able to use seven of the original bits, from two different LLR samples. Techniques are provided below which may be used when using partial LLR samples for soft combining or for other operations where full LLR samples are expected to be used.

Accordingly, for different transmissions or retransmissions, a different number of LLR bits may be stored each time (or the same number of bits may be stored, as appropriate).

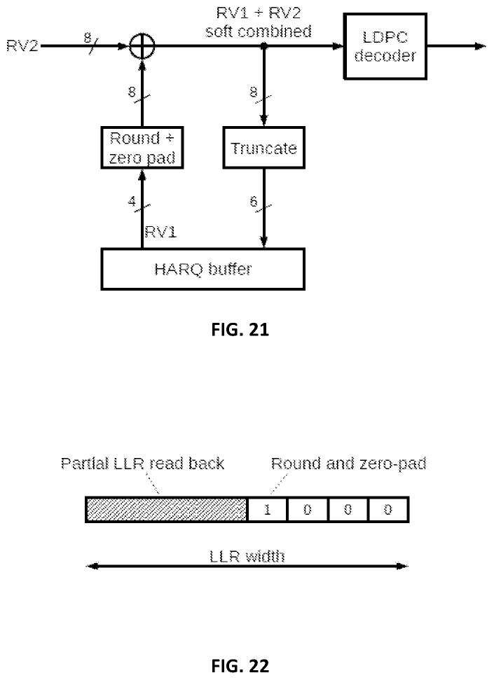

Once a portion of each LLR sample comprising the most significant bits of the LLR sample has been stored, the system has effectively stored a partial LLR sample rather than the full original LLR sample. When or if the LLR sample is needed for use, the stored information corresponds to a portion of the original LLR sample rather than the full LLR sample. However, the decoder might in some cases need a full LLR sample to operate. In such situations, different methods may be used (separately or in combination) in order to complete the LLR information to reach a useable size. Techniques for “padding” a partial LLR sample which can be used for using partial LLR samples for soft combining or other operations where full LLR samples are expected to be used are described below with reference to FIGS. 21 and 22.

FIG. 21 illustrates an example soft combining operation using partial LLR samples. In this example, the LLR sample for RV2 is received and is softly combined with the LLR sample for RV1 (or as softly combined after RV1 was received, depending on the implementation). In this example, the LLR sample that is read from memory is not a full size LLR sample, for example it is only a 4 bit sample rather than a log-compressed 6 bit sample or full size 8 bit sample (e.g. depending on how this particular system operates). Regardless of the reason(s) for the LLR sample being a partial one rather than a complete one (e.g. because only 4 bits were originally stored, because only 4 bits could be read, etc.), the system is expected to softly combine a partial LLR sample with a full LLR sample.

The LLR sample may for example be completed by adding information to the portion of the LLR that has not been stored (the “empty portion”). This can be done by adding bits to the empty portion, such as filling the empty portion based on one or more of: all empty bits set to zero, all empty bits set to one, bits randomly set to zero or one or bits set according to a pattern, the first (most significant) bit of the empty portion set to one and all others set to zero (which can also be referred to as “rounding up”), the first bit of the empty portion set to zero and all others set to one (which can also be referred to as “rounding down”), etc. Example patterns include a pattern of “0-1-0-1-0-1- . . . ”, a pattern of “1-0-1-0-1-0- . . . ” or any other pattern deemed suitable.

FIG. 22 illustrates an example “padding” of a partial LLR sample using the “rounding up” technique. As can be seen, the LLR sample for RV1 is missing four bits and when there is an intention to use this (partial four bit) LLR sample as full (8 bit here) LLR sample, additional bits will be added. For rounding up a four bit sample into an eight bit sample, the most significant bit of the empty or missing portion is filled in with a “1” and any remaining bit is filled with a “0”. Using this technique full LLR samples can be obtained where the difference or error relative to the original LLR sample can be minimised and where the average performance of the padding is expected to be satisfactory.

Returning to FIG. 21, once the LLR sample is rounded up to a full size LLR sample, it can be soft combined with the incoming RV2 LLR sample and the soft combined LLR can be passed onto the decoder for attempting to decode the transmission. The soft combined LLR sample and/or the RV2 LLR sample may then be stored in memory. This can involved the LLR sample being truncated, e.g. using log-linear compression and/or any techniques provided herein to manage the memory load and operations.

It is noteworthy that such padding techniques may be used in combination with other techniques, for example with a log-linear compression and decompression technique. For example, we can consider a case where a 6 bit LLR sample is expected to be written once compressed from 8 bits to 6 bits using a log-linear compression and to be read before it is decompressed to 8 bits using a log-linear decompression. In such a case, the padding may be used to pad a partial LLR sample to 6 bit. Looking at the example of FIG. 22, the padding would then add a “1” in the most significant bit of the missing portion and would add a “0” to the last and 6^{th} bit. The padded bit can then be passed onto the log-linear decompressor for obtaining a full size 8 bit which can be used by the system.

The arrangement of FIG. 21 is an illustrative example and the padding can be implemented differently depending on how the system operates. As the skilled person will appreciate, the information can be added in memory later (e.g. if the load of the memory allows it in a suitable timeframe), can be added by the HARQ (or memory operation) manager when or after reading the stored LLR samples and/or by the decoder or any other user of the LLR samples.

In other cases, the decoder may be configured to operate using partial LLR samples, wherein this is taken into account as part of the decoding process such that the partial LLR samples do not require to be complete, e.g. to be of the same size as the original LLR sample.

It is pointed out that the header bits, if provided, may be stored in any appropriate way, for example separately from the LLR sample memory resources, at the end of the LLR memory resources, in the middle of the LLR memory resources, saved together or distributed amongst the resources, and so on. The header for the different transmissions may also be stored separately from each other. For example, a header for RV0 may be stored in a location associated with the information stored for the LLR samples for transmission RV0, a header for RV1 may be stored in a location associated with the information stored for the LLR samples for transmission RV1.

As the most significant bits are stored first for each LLR sample, the storing of the LLR samples (or of any other type of data) can be stopped before it is completed while still retaining useful information through the most significant bit of each LLR sample (or other type of data). In such cases, using the techniques disclosed herein can be preferable to store data while controlling the load on the memory and in particular how the limited reading and writing bandwidth of the memory is managed.

As the skilled person will appreciate, using this type of memory operations is particularly useful with some type of data, e.g. LLR samples, but may not be as helpful with other type of data. If for example the data to be stored is not expected to have data where the most significant bits are more helpful than less significant bits (e.g. if the data encodes a random number), then this way of storing the data may not be as suitable.

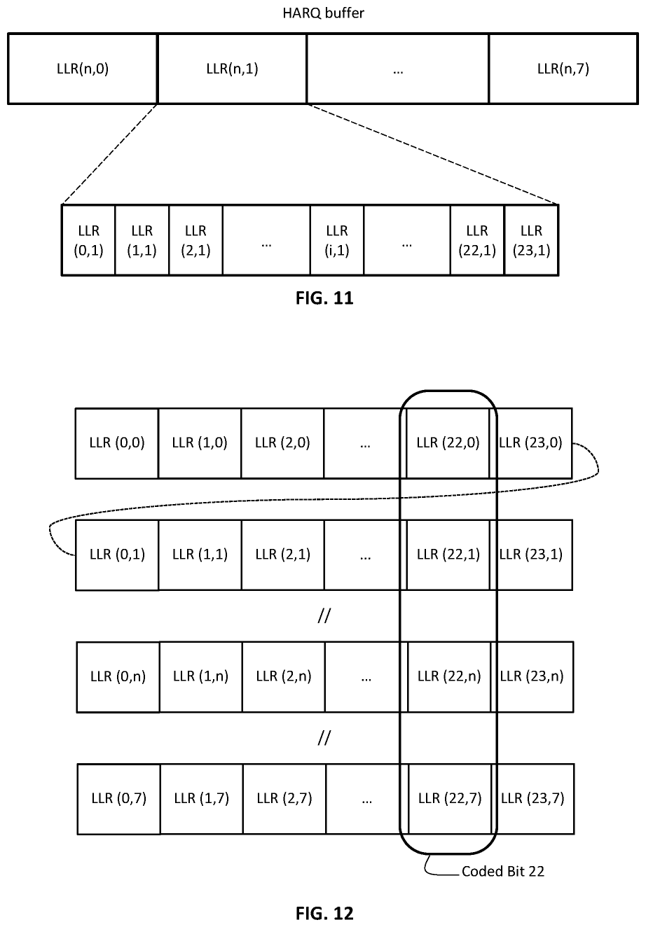

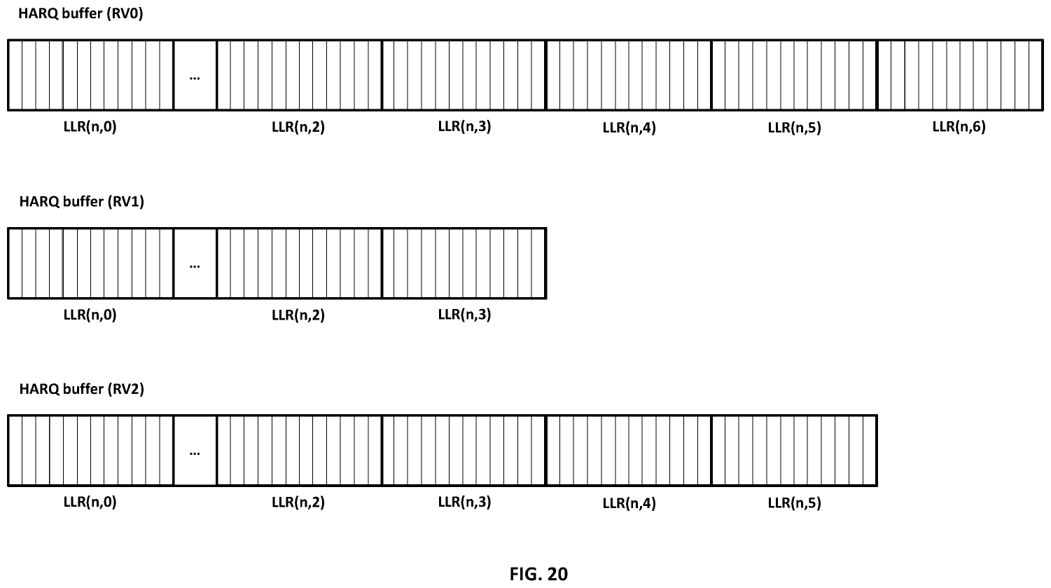

FIG. 11 illustrates another example of a HARQ buffer. In this example, the buffer is organised by most significant bits of the data (LLR samples in this case) to store. For example, the first section of the buffer entitled “LLR(n,0)” in FIG. 11 can store the most significant bit for each LLR sample (corresponding to a coded bit n). This can be for every LLR sample for every possible coded bit or can be for every LLR sample that was received at a particular transmission (see for example the discussion of FIG. 20 below).

For example, once the most significant bit for each LLR sample have been stored in LLR(n,0), the second most significant bit for the LLRs samples can be stored in LLR(n,1)-assuming that the writing operations have not been interrupted, for example due to an increase latency in memory operations.

By arranging the information by most significant bit rather of each LLR sample (or other type of data word) to be stored, the operation of the memory can be simplified when using techniques discussed herein. In particular, the bits to be stored in memory can be stored in memory in an order which corresponds to or similar to that of FIG. 11.

FIG. 12 illustrates another view of the HARQ buffer of FIG. 11. As shown therein, the entire LLR for each coded bit for which an LLR sample was received can be built again from the stored bit organised as illustrated in FIG. 11. This can be done by reordering the stored bits in a mirroring manner.

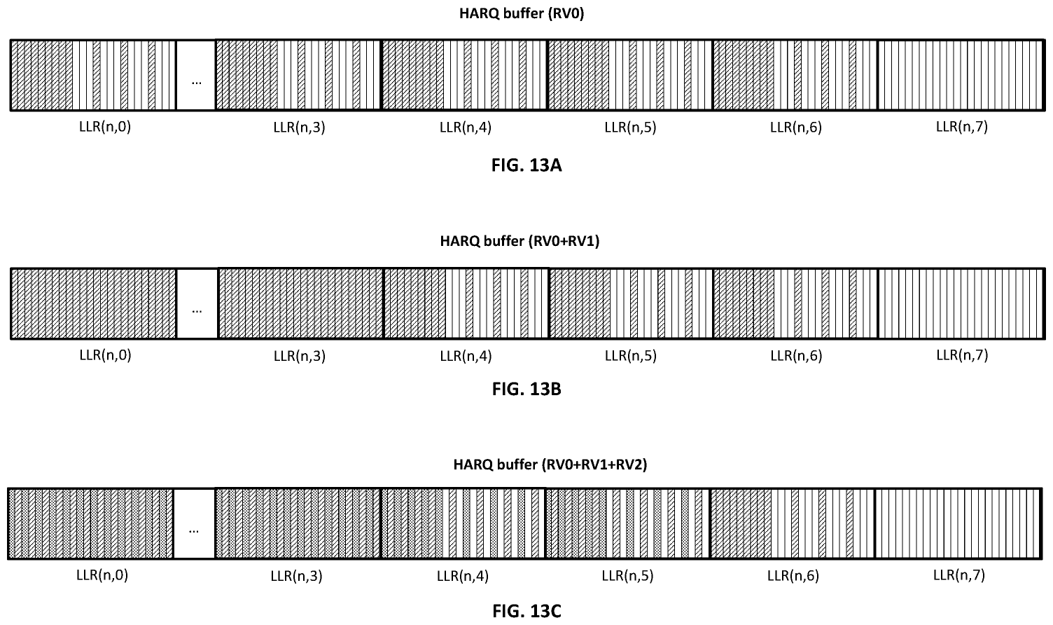

FIGS. 13A to 13C illustrate an example of which data is received with buffers of FIG. 11 during transmissions and re-transmissions. Although FIG. 13 may not correspond to the actual content of a HARQ buffer after the example transmissions RV0 to RV2, they schematically illustrate which LLR bits have been saved following the transmissions.

As can be seen in FIG. 13A, the seven most significant bits of each (8 bit) LLR sample for each received coded bit are stored after RV0. As explained above, in this example the writing operations are stopped after 7 bits at RV0, 4 bits at RV1 and 6 bits at RV2. It will be appreciated that this is merely an illustrative example and that more or fewer bits can be stored at each transmission—and the number of transmissions can also vary from RV0 only to up to RV3 in a conventional mobile network or, more generally to any number of transmissions deemed appropriate.

Following the same example as above, the four most significant bits for the LLR samples corresponding to the coded bits of the second transmission (first retransmission) RV1 are then stored, as illustrated in FIG. 13B.

Then, as illustrated in FIG. 13C, the six most significant bits of the LLR samples for the coded bits of the third transmission RV2 are then stored in memory.

In accordance with the techniques provided herein, the most significant bits of the LLR samples (or other data sets to store) are prioritised. This result in the greater density of bits received once or more in the part of the memory relating to the most significant bits, e.g. LLR(n,0) in FIG. 13C, compared to the less significant bits, e.g. LLR(n,5) or even less so LLR(n,7) in FIG. 13C.

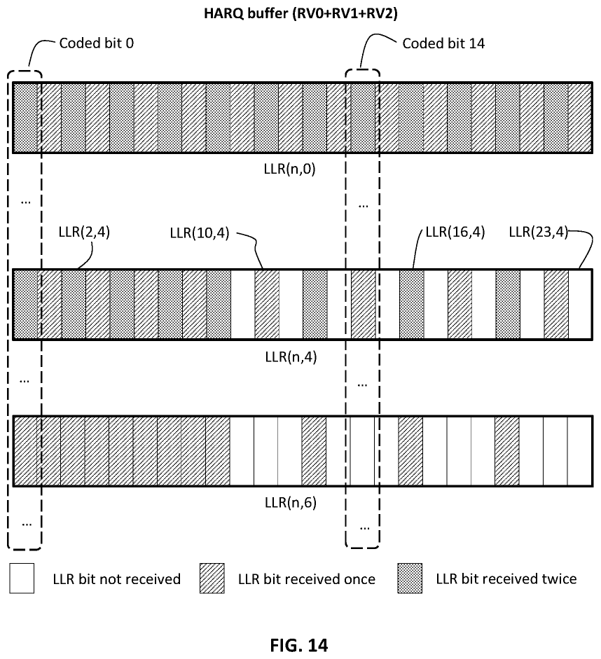

FIG. 14 illustrates an example use data stored in a buffer arranged as illustrated in FIG. 11, 12 or 13A-13C. Again, as can be seen in the example of FIG. 14, the density of information stored increases for more significant bits compared to less significant bits. Depending on which coded bits were transmitted at which transmission and on how many LLR bits were written for each corresponding transmission, there will be different amounts of LLR information for each coded bit and each transmission. The flexibility provided by the teachings and techniques of the present disclosure enable an improved responsiveness and adaptability when the memory used to store LLR information experiences delays or is overloaded. Accordingly, in some cases, rather than losing entire sets of LLR samples because they could not be written in time, some LLR information will be saved and the selection of which LLR information is saved will facilitate the processing of the transmissions despite the absence of complete LLR information. The dynamic compression of the LLR is thus tailored to respond to a condition of the memory and to prioritize the most important portions of the LLR samples (or other data sets) to be stored.

Additionally, the same teachings and techniques can be applied in a mirror manner for reading bits stored in memory. For example, the most significant bits of each LLR sample will be read first. Accordingly, even in an event where the reading operations are interrupted before all LLR sample bits available have been read, the system is expected to have (i) at least some information for the LLRs for each coded bit and (ii) for each LLR sample for each coded bit sent at each transmission, at least the most significant bits.

Accordingly, even if the reading operations are interrupted before they could complete, the risk of the interruption resulting in a failure to complete the overall decoding operation is reduced. Like for the benefits provided by the memory writing techniques discussed herein, the mirroring reading techniques reduce the risk of memory failure at least in part as a result of the prioritisation of the reading of most significant bits first and of successive attempting of reading (or writing) most significant bits for each LLR sample before moving on to less significant bits (for each LLR sample).

It will also be appreciated that while the writing and/or reading operations might be interrupted (e.g. as a result of the DDR scheduling or prioritising memory operations from one or more of the HARQ operations the channel estimator operations, other network operations or other memory operations), the writing and/or reading operations might also be configured based on a monitoring of the memory operations.

For example, in one arrangement, the writing and/or reading operations will be configured to write or read only a portion of the LLR samples in memory which will help reduce the amount of data transfers to and/or from memory. The size of the portion to be written or read can for example depend on a monitoring or status of the memory.

In this case, it is expected that the amount of data transfers to and/or from memory can be better controlled and it is expected that a controlled partial writing/reading operations management will result in fewer errors (compared to a case where all operations attempt to complete in the hope that they can complete before an interruption is experienced, e.g. caused by operations competing to access the memory). In addition, such an operation mode where there is are reduced write or read operations, in a planned fashion, is expected to cause fewer errors for the other functions using the same memory.

Table 1 below illustrates an example compression policy table which may be used by a controller and which can reduce the number of bits to be written in—or read from—memory depending on a measured congestion level. Accordingly, the controller may be configured based on two or more levels and can reduce the amount of data to be written and/or read in memory based on an expected load of the memory. In the particular example of Table 1, there are eight different congestion levels but it will be appreciated that more or fewer congestion or load levels may be used.

TABLE 1

| Congestion | | | | | | |
|---|---|---|---|---|---|---|
| Level | Q_Write(RV0) | Q_Read(RV1) | Q_Write(RV1) | Q_Read(RV2) | Q_Write(RV2) | Q_Read(RV3) |
| Level 1 | 6 | 6 | 6 | 6 | 6 | 6 |
| Level 2 | 6 | 6 | 6 | 6 | 3 | 3 |
| Level 3 | 6 | 6 | 3 | 3 | 3 | 3 |
| Level 4 | 3 | 3 | 3 | 3 | 3 | 0 |
| Level 5 | 3 | 3 | 3 | 3 | 0 | 0 |
| Level 6 | 3 | 3 | 3 | 0 | 0 | 0 |
| Level 7 | 3 | 0 | 0 | 0 | 0 | 0 |
| Level 8 | 0 | 0 | 0 | 0 | 0 | 0 |

This table would be well suited for an arrangement where it would expected that 6 bits would be written or read in memory when the memory's load allow it (e.g. in a case where a 6-bit compressed LLR would normally be written or read). The skilled person will appreciate that the particular values of table 1 may thus be adjusted based on any suitable parameter, such as the size of the data that is to be written or read, based on the number of load levels, based on the severity of the load level or congestion level reflected by the levels, based on the properties of the memory (e.g. how the memory behaves when the load increases and how operation errors can affect the memory), etc.

As will be appreciated, the amount of compression to be used can depend on one or more of: a state of the memory, a latency level associated with the memory, a transmission number, etc. For example, in Table 1, the components related to the memory itself are reflected by the congestion or load levels (Level 1 to Level 8) and the amount of compression is further indexed on a combination or the type of operation (read or write) and on a transmission number (RV0 to RV3 in this example).

In this example, the compression level is usually the same or higher (i.e. there is less data written or read) for the reading operations than for the writing operation when the same congestion level is experienced. This is expected to yield better results as the amount of reading that can be done will be limited by the amount of writing that had been done previously. It will however be appreciated that in some cases the same level of compression can be configured for both reading and writing operations, and more compression can be configured for reading operations compared to writing operations. This can be decided based for example on performances of a particular memory (e.g. reading and/or writing speed), on use of a particular memory (e.g. the type of reading or writing operations from “competing” memory users), etc.

The amount of compression to be effected for reading and/or writing operations based on the level of congestion experienced can be configured using one or more of: a control processor for the controller, a configuration file, a remote element, a message received from a remote device or the device comprising the memory, etc. In some cases, the controller may be configured with different combinations of congestion levels and compression levels and may receive an instruction to use a particular combination and/or determine to use a particular of these combinations.

According to the configuration, and for each memory read or write operation, the compression level (e.g. a desired word-length) associated with the current estimated congestion level is determined and can be used within the adaptive compression function.

In one example, a corresponding reporting table may be used which records a count for each entry (e.g. number of operations with this configuration of reading/writing, RV level and congestion level) so that the frequency of occurrence of each entry can be measured. In turn, this information can be used for example by the controller tune operation of the adaptive compression and/or to report to higher layers. In some examples, the level of compression can be adjusted and/or the granularity of each level can be adjusted once more information is available on how the system is used. For example, if the records show that many operations are carried out around a particular zone or zones in the table above and that operations outside this zone or zones are less frequent, the granularity of the congestion level and/or of the compression levels around this cluster can be increased to a finer granularity. In some cases, this can also be paired with a reduced granularity outside of the cluster for operations which are found to be less frequent. The tuning of the compression policy may alternatively or additionally be done jointly with tuning of other system functions and/or for different modes of operation. For example, in some systems or operation modes, a higher performance equaliser may be configured which will need greater access to memory. In this case, the compression level(s) may be reduced which is expected to result in better decoding performances. Depending on which other functions access the memory and whether and how the memory access of any such functions is controlled, different functions may be configured or prioritised so as to control the operation of the memory.

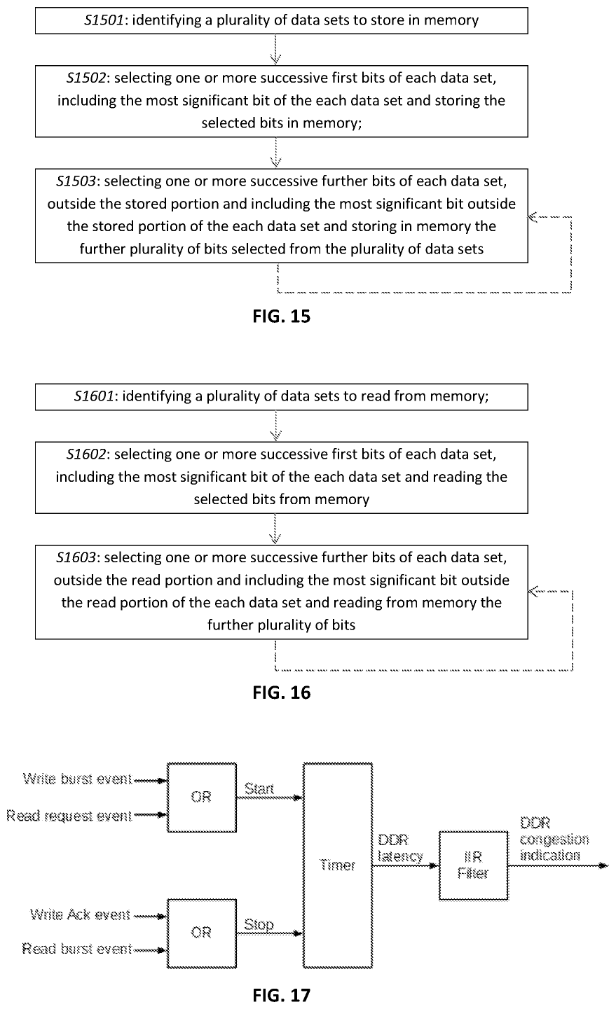

FIG. 15 illustrates an example method of the present disclosure, for storing information in memory. At S1501, a plurality of data sets to be stored in memory is identified. The data sets may for example be set of LLR words of LLR samples to be written in memory for future use. Then at S1502 one or more successive first bits of each data set, including the most significant bit of the each data set are selected and the selected bits are stored in memory. At S1503, one or more successive further bits of each data set are selected. The one or more successive further bits are selected outside the stored portion and including the most significant bit outside the stored portion of the each data set. Said differently, the one or more successive further bits can be seen as a selection, for each data set of the most significant bit of the remaining portion (that is, the portion of the each data set that has not yet been written) and optionally any subsequent bit, e.g. the second most significant bit, etc. The further plurality of bits selected from the plurality of data sets are then stored in memory.

Optionally, the method may return to step S1503, for example either until the entire data sets have been written (e.g. the write operation has completed) or until a predetermined number of bits have been written for each data set—determined for example based on Table 1 above.

Owing to this arrangement and to this writing of data which does not follow the actual organisation of the data sets, the writing can be carried in a manner which reduces the risk of errors if the writing is interrupted before completion. This is particularly useful with data wherein where the most significant bit of each data set is of greater importance to the meaning and use of the data compared to a less significant bit in the same data set.

Likewise, the same teachings apply equally to the reading operations, as illustrated in FIG. 16 which provides an example method for reading from memory. First at step S1601 a plurality of data sets to be read from memory is identified. The data sets may for example be set of LLR words of LLR samples already written in memory and to be read to try to decode a received transmission. At S1602 one or more successive first bits are selected for each data set, including the most significant bit of the each data set. The selected bits can then be read from memory. At S1603 one or more successive further bits are selected for each data set, outside the read portion (the portion read at S1602) and including the most significant bit outside the read portion of the each data set. The further plurality of bits can then be read from memory.

Optionally, the method can return to step S1603 and select further bits from the portion that has not been read yet. In some cases, the method will return to step S1603 until all of the written bits have been read (e.g. full LLR words or samples, or partial ones if the writing operation was previously truncated, in a telecommunications system) or until a stopping condition is met, for example in case a desired number of bits have been read from memory (for example derived from Table 1 above or any other suitable configuration or determination).

Owing to this arrangement and to this reading of data which, again, does not follow the actual organisation of the data sets, the reading can be carried in a manner which reduces the risk of errors if the reading is interrupted before completion. This is particularly useful with data wherein where the most significant bit of each data set is of greater importance to the meaning and use of the data compared to a less significant bit in the same data set.

FIG. 17 illustrates an example latency detection arrangement in accordance with the present disclosure. This example illustrates an example implementation for obtaining an estimation of the load or congestion of the memory, by measuring an estimated latency for memory operations. The example function of FIG. 17 can output a memory (DDR in this example) congestion indication. It comprises a timer which is started at the start of each DDR read or write burst and stopped when the DDR transaction is completed, or when in a timeout expires (where the timeout or timer can be configurable internally). A complete LLR buffer read or write may take many hundreds of DDR read or write bursts and DDR latency is measured for each one via this timer. With the example terminology of FIG. 17, a writing event starts with a “Write burst event” and a “write ack event” is received once terminated. A reading event starts with a “Read request event” and a “Read burst event” identifies the end of the reading event. It is expected that in many systems a “write ack event” or “read burst” should always happen, even if the writing or reading operation was interrupted (in which case, these events can sometimes be delayed before they happen, relative to the time of the interruption).

In this example a filter (which may for example be configurable) is included to smooth latency measurements with a view to avoiding triggering compression too early—in some cases, the filter may not be included and the latency data may be provided to the controller (which may or may not apply any data processing to this data before using it to control the read or write operations, e.g. to apply filter-like processing or any other processing).

An example natural language code for the Timer can for example be:

```
timer running = 0;
loop forever
  if (start)
    timer = 0
    timer_running = 1
  end
  if (timer_running)
    timer = timer + 1
    if (stop ∥ timer > timeout)
      ddr_latency = timer
      timer_running = 0
  end
  end
endloop
```

An example natural language code for the Filter can for example be:

if (ddr_latency > ddr_congestion_ind)
alpha =alpha_up
else
alpha =alpha_down
ddr_congestion_ind = ddr_latency * alpha + ddr_congestion_ind *
(1-alpha)

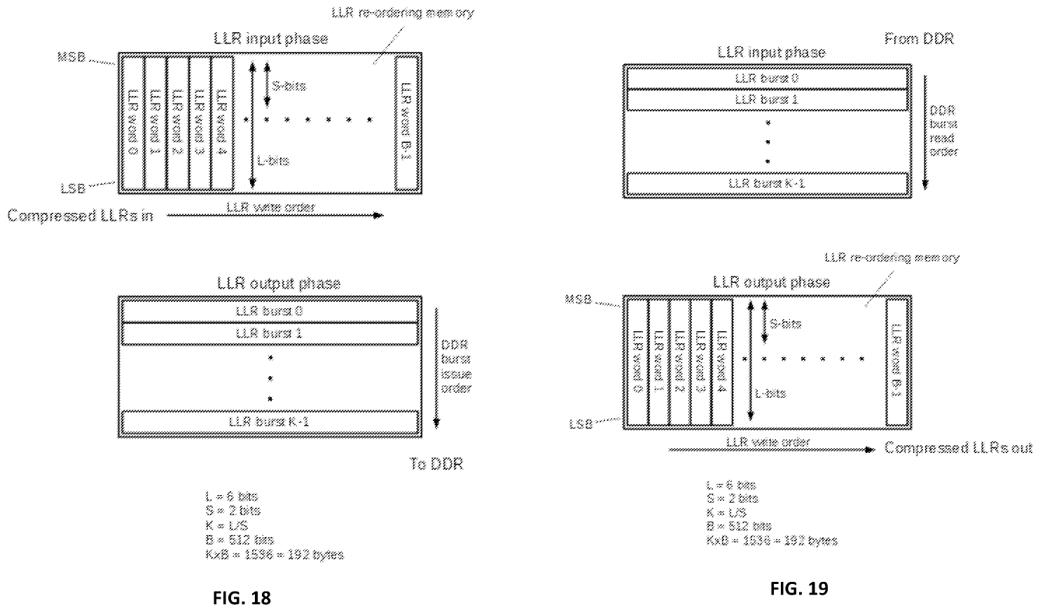

FIG. 18 illustrates an example memory re-ordering technique in an LLR-write operation. This re-ordering technique may be used with a view to implement the techniques provided herein. For example, rather than reading the input bit in their associated order for each data set (LLR word or samples in this example), the LLR samples can be written to an LLR re-ordering memory in a transposed order. For example, if they are expected to be read row by row when obtaining the bits to be stored in memory (e.g. DDR), the LLR samples may be stored in this re-ordering memory in a column-by-column manner.

Accordingly, and using the example of DDR memory, when enough samples have been read to form a DDR write burst (typically 512-bits), the re-ordering memory is read out row-by-row. As a result bits of equal significance are grouped together and the bits of most significant weight will be read before bits with a less significant weight. The number of rows written can be controlled by the controller, for example using the compression parameter Q_Write, which can be dynamically updated by the controller based on DDR congestion. In some cases, the number of rows written and/or the write operation can also be interrupted by other operations competing for memory access. On completion (with or without interruption), the Q(RV) value can be included in the HARQ buffer header and for example stored in DDR memory.

By ordering the data set in a buffer memory in a transposed manner relative to the order of reading the intermediate memory for writing the data in the ultimate memory (e.g. DDR), the implementation of the techniques discussed herein can be simplified and this additional step provides an efficient implementation of such techniques. In this example, a reading row-by-row (in the intermediate memory) of the bits to be stored can be associated with a storing of the data words column-by-column (in the intermediate memory) and, likewise, a reading column-by-column (in the intermediate memory) of the bits to be stored can be associated with a storing of the data words in row-by-row (in the intermediate memory).

FIG. 19 illustrates an example memory re-ordering technique in an LLR-read operation. This mirrors the discussion of FIG. 18 wherein the reading in the memory of the bits in one direction will be associated with data sets read in the transposed direction. In this example, the bits are read row-by-row in the DDR memory and stored in an intermediate memory from which the data sets can be reconstructed by reading column-by-column.

In a system such as the one illustrated in FIG. 9, the number of rows read can be controlled by de-compression parameter Q_read, which can be dynamically updated by the compression controller based on DDR congestion and the relevant HARQ buffer header Q(RV) value.

It will be appreciated that in some cases bits may not be available to have the complete DDR sample (e.g. if the writing was truncated or interrupted). Also, in some cases, the reading itself will be truncated or interrupted. Accordingly and as discussed above, in some cases an incomplete LLR sample may sometimes be completed by padding of the portion of the LLR that has not been read (because it was not previously stored and/or because it was not read).

While the illustration of FIGS. 18 and 19 show data represented in a two-dimensional array, it will be appreciated that this is a schematic representation and that a suitable data structure may be implemented differently in other cases. For example, as illustrated in FIG. 20 which shows an example of bit ordering in a memory, the data can be stored in a list or table (e.g.-one dimensional array). In this case, once the data from the data sets (e.g. LLR samples) has been provided in the expected order to the memory, the data will be re-arrange in a suitable order in the memory. In this case, the data can then be read from memory starting from the start of the data structure until either the end is reached or the read operation is interrupted. This is similar to how the writing and reading is done in FIGS. 18 and 19, but using a different data structure. The skilled person will also appreciate to other suitable data structures may also be used.

While the example implementation herein mainly rely on a write or read operation on the next most significant bit of the data set before carrying the operation on the bit in the same position on the next data set (or the next significant bit in the first data set if already at the last data set), it will be appreciated that more than one bit may be written or read from each data set or LLR sample each time. For example, the system may operate with pairs of bits and write/read two bits of each word at every loop (unless only one bit is left in a word). In other cases, a variable number of bits may be used, selected between 1 and a suitable number n.

From one perspective, the LLR samples can be viewed as data sets and in some cases, each data set is a bit word Wᵢ having N ordered bits Wᵢ(0) to Wᵢ(N−1), with N≥2. In some examples, the words will be read or written by reading or writing first all of the Wᵢ(0) for each word Wᵢ, then all of the Wᵢ(1), all of the Wᵢ(2), etc. until a stopping condition is reached and/or until the operation is interrupted. In examples where more than one bit is read or written at a time, the data sets may be read or written as follows: first all Wᵢ(0, 1), then all of Wᵢ(2,3) etc. In another example, the data sets may be read or written as follows: Wᵢ(0,1); then Wᵢ(2); then Wᵢ(3, 4, 5), etc. This may be based on a predetermined pattern or adjusted dynamically, if appropriate.

The skilled person will appreciate that although some of the examples above have been illustrated with two retransmissions (up to RV2), the number of retransmissions may be more or less than two and the same teachings and techniques will apply equally to such situations. It is also noted that while techniques of the present disclosure will found particular use in field of telecommunications and for example with the use of 5G or New Radio (NR), these techniques are not limited to these particular fields of use.

Likewise, while it is expected that the present techniques will be used in a system using incremental redundancy, these techniques can be used in other arrangements which do not use incremental redundancy, or even which do not use redundancy. Some of the technical strengths of these techniques are particularly well suited to data such as LLR data but other types of data may share similar characteristics and may thus also be well suited for use with the techniques discussed herein.

As will be appreciated, the teachings and techniques provided herein may be applied to any suitable memory, for example a single memory provided using a single device or multiple storing devices. The memory may also be distributed across multiple devices and/or may be a virtual memory. In some illustrative examples, the memory may be provided as a Double Data Rate “DDR” memory, such as a Synchronous Dynamic Random-Access Memory “SDRAM”.

As will be appreciated some of the example features discussed above, while useful in combination with the techniques provided herein should be not understood as limiting the scope of the present disclosure. For example, the use of a linear logarithmic compression step is an optional step.

Additionally, the teachings and techniques provided herein are expected to be particularly useful with the use of DDR memory but other types of memory may be used when implementing these teachings and techniques.

The present disclosure includes example arrangements falling within the scope of the claims (and other arrangements may also be within the scope of the following claims) and may also include example arrangements that do not necessarily fall within the scope of the claims but which are then useful to understand the teachings and techniques provided herein.

Example aspects of the present disclosure are presented in the following numbered clauses:

Clause 1. A method of controlling memory operations, the method comprising:
identifying a plurality of data sets to store in memory, each data set comprising two or more bits ordered from a most significant bit to a least significant bit;
storing in memory a first plurality of bits selected from the bits for the plurality of data sets, wherein the first plurality of bits is selected by selecting one or more successive first bits of each data set, including the most significant bit of the each data set, wherein the stored one or more successive first bits of the each data set define a stored portion of the each data set; and
storing in memory a further plurality of bits selected from the bits for the plurality of data sets, wherein the further plurality of bits is selected by selecting one or more successive further bits of each data set, outside the stored portion and including the most significant bit outside the stored portion of the each data set.

Clause 2. The method of Clause 1, further comprising, when a stopping event being detected, stopping the step of storing a further plurality of bits before completion of the step.

Clause 3. The method of Clause 1 or 2 wherein the method further comprising
subsequent to the step of storing a further plurality of bits, updating for each data set the stored portion to comprise the stored one or more successive further bits of the each data set;
repeating the storing a further plurality of bits step and updating step, until a stopping criterion is met, wherein a stopping criterion comprises one or more of:
each of the plurality of data sets being fully stored in memory and
a stopping event being detected.

Clause 4. The method of Clause 2 or 3 wherein a stopping event is triggered by one or more of:
a stopping parameter being met, the stopping parameter indicating a number of repeat times for repeating the step of storing a further plurality of bits;
an instruction to stop storing the plurality of data sets in memory;
a detection of a load of the memory being above a threshold; and
a detection of a latency performance of the memory being above a threshold.

Clause 5. The method of any one of Clauses 2 to 4 further comprising, upon detection of a stopping event and upon detection that a first data set of the plurality of data set has not been fully stored in memory, storing an indication that the storing of the first data set has been interrupted.

Clause 6. The method of Clause 5 wherein the indication comprises an indication of the number of bits of the first data set that have been stored in memory.

Clause 7. The method of any one of Clauses 2 to 6 further comprising
measuring a performance of the memory; and
setting a stopping parameter based on the measured performance,
wherein a stopping event is triggered at least by the stopping parameter being met.

Clause 8. The method of any preceding Clause wherein selecting one or more successive first bits of each data set comprises selecting only the most significant bit of the each data set as the one or more successive first bits of each data set.

Clause 9. The method of any preceding Clause wherein selecting one or more successive further bits of each data set comprises selecting only the most significant bit outside the stored portion of the each data set as one or more successive further bits of each data set.

Clause 10. The method of any preceding Clause wherein each data set is at least one of
a Log-likelihood ratio “LLR”;
associated with a coded bit;
a representation of an expected value of a coded bit.

Clause 11. The method of any preceding Clause wherein each data set is a bit word Wi having N ordered bits Wi(0) to Wi(N−1), with N greater than or equal to 2.

Clause 12. The method of Clause 11 further comprising:
receiving a number L of bit words, with L greater than or equal to 2,
storing the plurality of bit words in a re-ordering memory wherein each bit word is stored in a corresponding one of L rows, or columns, of the re-ordering memory;
sequentially reading memory bits of the re-ordering memory and storing the read bits in memory, by reading the re-ordering memory column-by-column, or row-by-row, respectively.

Clause 13. The method of Clause 11 or 12, further comprising:
receiving a number L of bit words W0 to WL−1, with L greater than or equal to 2,
storing the plurality of bit words in a re-ordering memory having L times N memory bits Mj) from position j=0 to position j=N×L−1, comprising storing each bit word Wᵢ in the re-ordering memory by storing bit Wi(k) in memory position M(i+k×L)
sequentially reading memory bits Mj) from j=0 and storing the read memory bits in memory.

Clause 14. The method of Clause 12 or 13 further comprising stopping the reading and storing the read bits in memory when a stopping criterion is met.

Clause 15. The method of any preceding Clause wherein the memory is a Double Data Rate “DDR” Synchronous Dynamic Random-Access Memory “SDRAM”.

Clause 16. A method of controlling memory operations, the method comprising:
identifying a plurality of data sets to read from memory, each data set comprising two or more bits ordered from a most significant bit to a least significant bit;
reading from memory a first plurality of bits selected from the bits for the plurality of data sets, wherein the first plurality of bits is selected by selecting one or more successive first bits of each data set, including the most significant bit of the each data set, wherein the read one or more successive first bits of the each data set define a read portion of the each data set; and
reading from memory a further plurality of bits selected from the bits for the plurality of data sets, wherein the further plurality of bits is selected by selecting one or more successive further bits of each data set, outside the read portion and including the most significant bit outside the read portion of the each data set.

Clause 17. The method of Clause 16, further comprising, when a stopping event being detected, stopping the step of read a further plurality of bits before completion of the step.

Clause 18. The method of Clause 16 or 17 wherein the method further comprising
subsequent to the step of read a further plurality of bits, updating for each data set the read portion to comprise the read one or more successive further bits of the each data set;
repeating the read a further plurality of bits step and updating step, until a stopping criterion is met, wherein a stopping criterion comprises one or more of:
each of the plurality of data sets being fully read from memory and
a stopping event being detected.

Clause 19. The method of Clause 17 or 18 wherein a stopping event is triggered by one or more of:
a stopping parameter being met, the stopping parameter indicating a number of repeat times for repeating the step of reading a further plurality of bits;
an instruction to stop reading the plurality of data sets in memory;
a detection of a load of the memory being above a threshold;
a detection of a latency performance of the memory being above a threshold; and
a determination, based on an indicator, that an earlier step of storing plurality of the data sets had been interrupted and that the first portion of the plurality of data sets stored during the earlier step have all been read.

Clause 20. The method of any one of Clauses 17 to 19 further comprising, upon detection of a stopping event, associating a value with bits of the plurality of data sets that have not been read from memory to generate full data sets.

Clause 21. The method of any one of Clauses 16 to 20, wherein selecting one or more successive first bits of each data set comprises selecting only the most significant bit of the each data set as the one or more successive first bits of each data set.

Clause 22. The method of any one of Clauses 16 to 21, wherein selecting one or more successive further bits of each data set comprises selecting only the most significant bit outside the read portion of the each data set as one or more successive further bits of each data set.

Clause 23. The method of any one of Clauses 16 to 22 wherein, upon detection that an earlier step of storing plurality of the data sets had been interrupted and that the portion of the plurality of data sets stored during the earlier step have all been read, associating a value with bits of the plurality of data sets outside the first portion to generate full data sets.

Clause 24. The method of any one of Clauses 16 to 23, wherein each data set is at least one of:
a Log-likelihood ratio “LLR”;
associated with a coded bit;
a representation of an expected value of a coded bit.

Clause 25. The method of any one of Clauses 16 to 24, wherein each data set is a bit word Wi having N ordered bits Wi(0) to Wi(N−1), with N greater than or equal to 2.

Clause 26. The method of Clause 25 further comprising:
receiving a number L of bit words, with L greater than or equal to 2,
when the bit words are stored in memory in column-by-column, or row-by-row, order, sequentially reading stored bits and storing the read bits in a re-ordering memory, by writing the read bits re-ordering memory in a row-by-row order, or column-by-column order, respectively thereby storing each bit word is in a corresponding one of L rows, or columns, respectively, of the re-ordering memory.

Clause 27. The method of Clause 25 or 26 further comprising stopping the reading and storing the read bits in the re-ordering memory when a stopping criterion is met.

Clause 28. The method of any one of Clauses 16 to 27, wherein the memory is a Double Data Rate “DDR” Synchronous Dynamic Random-Access Memory “SDRAM”.

Clause 29. A controller for controlling memory operations, controller being configured to:
identify a plurality of data sets to store in memory, each data set comprising two or more bits ordered from a most significant bit to a least significant bit;
store in memory a first plurality of bits selected from the bits for the plurality of data sets, wherein the first plurality of bits is selected by selecting one or more successive first bits of each data set, including the most significant bit of the each data set, wherein the stored one or more successive first bits of the each data set define a stored portion of the each data set; and
store in memory a further plurality of bits selected from the bits for the plurality of data sets, wherein the further plurality of bits is selected by selecting one or more successive further bits of each data set, outside the stored portion and including the most significant bit outside the stored portion of the each data set.

Clause 30. The controller of Clause 29, wherein the controller is further configured to implement the method of any one of Clauses 2 to 15.

Clause 31. A controller for controlling memory operations, controller being configured to:
identify a plurality of data sets to read from memory, each data set comprising two or more bits ordered from a most significant bit to a least significant bit;
read from memory a first plurality of bits selected from the bits for the plurality of data sets, wherein the first plurality of bits is selected by selecting one or more successive first bits of each data set, including the most significant bit of the each data set, wherein the read one or more successive first bits of the each data set define a read portion of the each data set; and
read from memory a further plurality of bits selected from the bits for the plurality of data sets, wherein the further plurality of bits is selected by selecting one or more successive further bits of each data set, outside the read portion and including the most significant bit outside the read portion of the each data set.

Clause 32. The controller of Clause 31, wherein the controller is further configured to implement the method of any one of Clauses 16 to 28.

Clause 33. A controller system comprising:
a reading controller in accordance with Clause 29 or 30; and
a writing controller in accordance with Clause 31 or 32.

1-33. (canceled)

34. A method of controlling memory operations, the method comprising:
identifying a plurality of data sets to store in memory, each data set comprising two or more bits ordered from a most significant bit to a least significant bit;
storing in memory a first plurality of bits selected from the bits for the plurality of data sets, wherein the first plurality of bits is selected by selecting one or more successive first bits of each data set, including the most significant bit of the each data set, wherein the stored one or more successive first bits of the each data set define a stored portion of the each data set; and
storing in memory a further plurality of bits selected from the bits for the plurality of data sets, wherein the further plurality of bits is selected by selecting one or more successive further bits of each data set, outside the stored portion and including the most significant bit outside the stored portion of the each data set.

35. The method of claim 34, further comprising, when a stopping event being detected, stopping the step of storing a further plurality of bits before completion of the step.

36. The method of claim 34 wherein the method further comprises:
subsequent to the step of storing a further plurality of bits, updating for each data set the stored portion to comprise the stored one or more successive further bits of the each data set;
repeating the storing a further plurality of bits step and updating step, until a stopping criterion is met, wherein a stopping criterion comprises one or more of:
each of the plurality of data sets being fully stored in memory and
a stopping event being detected.

37. The method of claim 35 wherein a stopping event is triggered by one or more of:
a stopping parameter being met, the stopping parameter indicating a number of repeat times for repeating the step of storing a further plurality of bits;
an instruction to stop storing the plurality of data sets in memory;
a detection of a load of the memory being above a threshold; and
a detection of a latency performance of the memory being above a threshold.

38. The method of claim 35 further comprising, upon detection of a stopping event and upon detection that a first data set of the plurality of data set has not been fully stored in memory, storing an indication that the storing of the first data set has been interrupted.

39. The method of claim 38 wherein the indication comprises an indication of the number of bits of the first data set that have been stored in memory.

40. The method of claim 35 further comprising
measuring a performance of the memory; and
setting a stopping parameter based on the measured performance,
wherein a stopping event is triggered at least by the stopping parameter being met.

41. The method of claim 34 wherein selecting one or more successive first bits of each data set comprises selecting only the most significant bit of the each data set as the one or more successive first bits of each data set.

42. The method of claim 34 wherein selecting one or more successive further bits of each data set comprises selecting only the most significant bit outside the stored portion of the each data set as one or more successive further bits of each data set.

43. The method of claim 34 wherein each data set is at least one of
a Log-likelihood ratio “LLR”;
associated with a coded bit;
a representation of an expected value of a coded bit.

44. The method of claim 34 wherein the memory is a Double Data Rate “DDR” Synchronous Dynamic Random-Access Memory “SDRAM”.

45. A method of controlling memory operations, the method comprising:
identifying a plurality of data sets to read from memory, each data set comprising two or more bits ordered from a most significant bit to a least significant bit;
reading from memory a first plurality of bits selected from the bits for the plurality of data sets, wherein the first plurality of bits is selected by selecting one or more successive first bits of each data set, including the most significant bit of the each data set, wherein the read one or more successive first bits of the each data set define a read portion of the each data set; and
reading from memory a further plurality of bits selected from the bits for the plurality of data sets, wherein the further plurality of bits is selected by selecting one or more successive further bits of each data set, outside the read portion and including the most significant bit outside the read portion of the each data set.

46. The method of claim 45, further comprising, when a stopping event being detected, stopping the step of read a further plurality of bits before completion of the step.

47. The method of claim 45 wherein the method further comprises:
subsequent to the step of read a further plurality of bits, updating for each data set the read portion to comprise the read one or more successive further bits of the each data set;
repeating the read a further plurality of bits step and updating step, until a stopping criterion is met, wherein a stopping criterion comprises one or more of:
each of the plurality of data sets being fully read from memory and
a stopping event being detected.

48. The method of claim 46 wherein a stopping event is triggered by one or more of:
a stopping parameter being met, the stopping parameter indicating a number of repeat times for repeating the step of reading a further plurality of bits;
an instruction to stop reading the plurality of data sets in memory;
a detection of a load of the memory being above a threshold;
a detection of a latency performance of the memory being above a threshold; and
a determination, based on an indicator, that an earlier step of storing plurality of the data sets had been interrupted and that the first portion of the plurality of data sets stored during the earlier step have all been read.

49. A controller for controlling memory operations, controller being configured to:
identify a plurality of data sets to store in memory, each data set comprising two or more bits ordered from a most significant bit to a least significant bit;
store in memory a first plurality of bits selected from the bits for the plurality of data sets, wherein the first plurality of bits is selected by selecting one or more successive first bits of each data set, including the most significant bit of the each data set, wherein the stored one or more successive first bits of the each data set define a stored portion of the each data set; and
store in memory a further plurality of bits selected from the bits for the plurality of data sets, wherein the further plurality of bits is selected by selecting one or more successive further bits of each data set, outside the stored portion and including the most significant bit outside the stored portion of the each data set.

50. The controller of claim 49, wherein the controller is further configured for, when a stopping event is detected, stopping the step of store in memory a further plurality of bits before completion of the step of store in memory a further plurality of bits.

51. A controller for controlling memory operations, controller being configured to:
identify a plurality of data sets to read from memory, each data set comprising two or more bits ordered from a most significant bit to a least significant bit;
read from memory a first plurality of bits selected from the bits for the plurality of data sets, wherein the first plurality of bits is selected by selecting one or more successive first bits of each data set, including the most significant bit of the each data set, wherein the read one or more successive first bits of the each data set define a read portion of the each data set; and
read from memory a further plurality of bits selected from the bits for the plurality of data sets, wherein the further plurality of bits is selected by selecting one or more successive further bits of each data set, outside the read portion and including the most significant bit outside the read portion of the each data set.

52. The controller of claim 51, wherein the controller is further configured for:
identifying a plurality of data sets to read from memory, each data set comprising two or more bits ordered from a most significant bit to a least significant bit;
reading from memory a first plurality of bits selected from the bits for the plurality of data sets, wherein the first plurality of bits is selected by selecting one or more successive first bits of each data set, including the most significant bit of the each data set, wherein the read one or more successive first bits of the each data set define a read portion of the each data set; and
reading from memory a further plurality of bits selected from the bits for the plurality of data sets, wherein the further plurality of bits is selected by selecting one or more successive further bits of each data set, outside the read portion and including the most significant bit outside the read portion of the each data set.

53. A controller system comprising:
a reading controller configured to:
identify a plurality of data sets to store in memory, each data set comprising two or more bits ordered from a most significant bit to a least significant bit;
